(19) United States
(12) Patent Application Publication
(10) Pub. No.: US 2012/0096766 A1
(43) Pub. Date: Apr. 26, 2012

(54) MODULAR GARDEN BED ASSEMBLY

(76) Inventors: Neill Jonathan Bosch, Queensland (AU); Simon William Bird, Queensland (AU)

(21) Appl. No.: 13/375,450

(22) PCT Filed: Jun. 7, 2010
(86) PCT No.: PCT/AU2010/000703

§ 371 Date: Jan. 12, 2012

(30) Foreign Application Priority Data
Jun. 5, 2009 (AU) 2009902594
Jun. 25, 2009 (AU) 2009902965

(51) Int. Cl. A01G 1/08

(52) U.S. Cl. 47/33

(57) ABSTRACT

A modular garden bed assembly which comprises a plurality of garden bed members, each garden bed member including a wall and a connecting arrangement on each of a pair of opposed, operatively vertical ends of the wall, the garden bed members arranged consecutively with respect to each other, with connecting arrangements of respective consecutive walls connected to each other so that the walls bound a volume in which soil for planting can be retained by the walls.

### TECHNICAL FIELD

The invention described herein relates to a garden bed assembly. In particular, the invention is directed to a modular garden bed assembly and to a kit for a modular garden bed assembly, although the scope of the invention is not necessarily limited thereto.

### BACKGROUND ART

In recent years, it has become the practice of many property owners, particularly those in suburban areas, to grow their own vegetables. As is known, it is usually necessary for a gardener to use a raised garden bed in which soil is retained. Raised garden beds are provided in many forms. The most basic form is one which uses timber shuttering which encloses a volume into which the soil is placed prior to planting. Other basic forms are those which use construction blocks or rocks to enclose and retain the soil.

A problem with such garden beds is that they are not readily stored and transported, either because of their size or weight.

The use of raised garden beds is particularly widespread in areas in which the soil is poor and/or where good drainage is required. However, building a raised garden bed can be a time-consuming and difficult affair. One of the reasons for this is that it is often necessary to assemble cumbersome elements, such as rocks, building blocks and timber sleepers to define the volume in which the soil is to be retained.

Recently, the Applicants have conceived and developed a garden bed assembly of one or more sheets of corrugated material. In particular, the Applicant has used corrugated sheeting to assemble garden beds. The corrugated sheeting is generally of metal and can be of different gauges depending on the requirements. For example, the gauge can be that conventionally used for water tanks or that conventionally used for roofing.

The Applicants have found that it can be difficult to accessorize such garden beds due to the unique profile of the corrugated sheeting.

### SUMMARY OF THE INVENTION

According to a first embodiment of the invention, there is provided a modular garden bed assembly which comprises

a plurality of garden bed members, each garden bed member including a wall and a connecting arrangement on each of a pair of opposed, operatively vertical ends of the wall, the garden bed members arranged consecutively with respect to each other, with connecting arrangements of respective consecutive walls connected to each other so that the walls bound a volume in which soil for planting can be retained by the walls.

Each connecting arrangement may include a series of openings defined in respective said vertical edges of the walls such that the openings in consecutive walls can be brought into register with each other when said vertical ends of the consecutive walls overlap to permit the walls to be fastened to each other with fasteners received through the openings.

The invention thus provides a means whereby a garden bed assembly can be supplied in a relatively compact manner. This allows the garden bed assembly to be sold at retail outlets in which the customer generally packs and transports purchased items in his or her own vehicle. As the DIY market has grown, such retail outlets have become more and more popular.

Thus, according to a second embodiment of the invention, there is provided a kit for a modular garden bed assembly, the kit comprising

a plurality of garden bed members, each garden bed member including a wall and a connecting arrangement on each of a pair of opposed operatively vertical ends of the wall, such that the garden bed members can be arranged consecutively with respect to each other, the connecting arrangements of respective consecutive walls being capable of being connected to each other so that the walls can bound a volume in which soil for planting can be retained by the walls.

It will be appreciated that the garden bed members can take a number of different shapes. For ease of packing and storage, the garden bed members may be shaped to facilitate nesting of the garden bed members in a pre-assembled configuration.

Each wall may be in the form of a length of corrugated metal sheeting, for example, of the type used in construction and fabrication of storage containers such as water tanks. The corrugated metal sheeting may also be of the type used for roofing, which is of a thicker gauge than the water tank material. The openings may be positioned in peaks and troughs of respective operatively vertical edges to facilitate registration of the openings.

Said fasteners received through the openings may be in the form of nut and bolt arrangements.

The modular garden bed assembly may include a protective beading strip that can be positioned on an upper, operatively horizontal edge of the walls to protect a user against cuts.

According to a further aspect of the invention, there is provided an accessory for a garden bed assembly, the accessory comprising:

a mounting member configured for operative engagement with an operatively horizontal edge of a wall of the garden bed assembly; and

a support formation arranged on the mounting member so that the mounting member can support a device for use with the garden bed assembly.

The garden bed is particularly of the type assembled from one or more sheets of corrugated material. For example, such material can be of galvanised metal. The sheets can be of different gauges such as a thinner gauge conventionally used for the fabrication of water tanks or of a thicker gauge conventionally used for roofing. Thus, the mounting member may be configured so that it can be urged into engagement with a free edge of such a sheet to engage respective corrugations defined by the sheet.

In one embodiment, the mounting member may be in the form of a bar which is shaped so that one end can be hooked over said free edge of the sheet while an opposite end is shaped to carry the device and thus defines the support formation. In this particular embodiment, a ferrule may be positioned on said opposite end. A pole may be received in the ferrule to support a cover for the garden bed, such as a netting system. It will be appreciated that, in use, a plurality of the accessories of this embodiment will be provided to support the netting system.

In another embodiment, the mounting member may be in the form of a clip-on member. The support formation may be configured to support a bench suitable for use by a gardener for planting or potting.

In another embodiment, the mounting member may also be in the form of a clip-on member. However, in this embodiment, the support formation may be configured to support a trellis system for use with climbing plants.

In order that the invention may be more readily understood and put into practice, one or more preferred embodiments thereof will now be described, by way of example only, with reference to the accompanying drawings. The following description is merely for the purpose of allowing a person of ordinary skill in the art to carry out preferred embodiment/s of the invention. Accordingly, the following description is not intended to limit the scope of the preceding paragraphs or of the appended claims.

### BRIEF DESCRIPTION OF THE DRAWINGS

FIG. 1 shows a plan view of a modular garden bed assembly, in accordance with a first embodiment of the invention, assembled with a kit, in accordance with a second embodiment of the invention, for a garden bed assembly.

FIG. 2 shows a longer side of the modular garden bed assembly.

FIG. 3 shows a shorter side of the modular garden bed assembly.

FIG. 4 shows detail of a connecting arrangement of the modular garden bed assembly.

FIG. 5 shows a schematic side view of a first embodiment, in accordance with an aspect of the invention, of an accessory for a garden bed assembly.

FIG. 6 shows a schematic side view of a second embodiment, in accordance with an aspect of the invention, of an accessory for a garden bed assembly.

FIG. 7 shows a schematic side view of a third embodiment, in accordance with an aspect of the invention, of an accessory for a garden bed assembly.

FIG. 8 is a schematic sectional view of an alternative connecting arrangement of the modular garden bed assembly.

FIG. 9 is a schematic view of a bracing assembly according to an aspect of the present invention.

FIG. 10 illustrates a variety of shapes and sizes of garden bed that the preferred embodiment of the present invention may be assembled into.

### DETAILED DESCRIPTION OF PREFERRED EMBODIMENTS

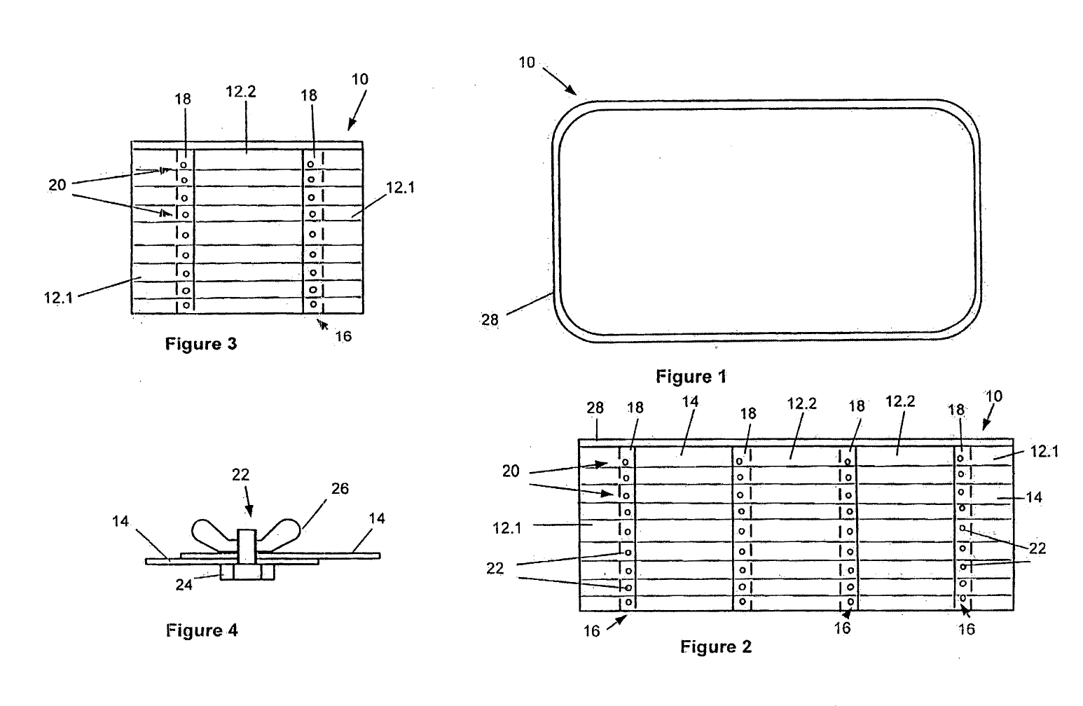

In FIGS. 1, 2 and 3, reference numeral 10 generally indicates a garden bed assembly, in accordance with the first embodiment of the invention, assembled with a kit, in accordance with a second embodiment of the invention, for a garden bed assembly. The kit can readily be ascertained from the drawings.

The garden bed assembly 10 includes a number of garden bed members 12. In this example, there are twelve garden bed members 12 assembled together to form a rectangular garden bed with rounded corners. Four of the garden bed members 12.1 are arcuate in plan profile and are substantially identical to each other to provide the rounded corners. The remaining eight garden bed members 12.2 are substantially straight and identical to each other. It follows that the garden bed members 12 can readily be stacked together for storage and transport, particularly by the end user. Thus, this embodiment of the invention is particularly suited for display and sale at retail outlets targeted at end users.

Each garden bed member 12 includes a wall 14. The wall 14 is of corrugated metal sheeting, such as that used for construction and fabrication of storage containers such as water tanks. The metal sheeting can also be of the type which is used as roofing, which is of a thicker gauge than the water tank material. Such metal sheeting is usually of galvanised steel or aluminium, which makes it particularly suited for outdoor use, and particularly for retaining soil.

Each member 12 has a pair of connecting arrangements 16 on opposite, operatively vertical edges 18 for connecting the members to each other. More specifically, the connecting arrangements 16 each include a series of openings 20 defined in the vertical edges 18. The walls 14 are arranged with respect to each other so that the edges 18 overlap with the openings 20 in register with each other. The openings 20 are defined in respective peaks and troughs of the walls 14 to facilitate alignment of the openings 20.

The connecting arrangements 16 include fasteners 22 that are received through respective pairs of corresponding openings 20 to fasten the members 12 to each other. Each fastener 22 is in the form of a bolt and nut combination, such as a bolt 24 and wing-nut 26 combination to facilitate assembly of the garden bed without tools.

The garden bed assembly 10 includes a protective beading strip 28. The strip 28 can be arranged on an upper, operatively horizontal edge of the members 12 to protect a user against cuts.

Instead of the bolt and nut combinations, the connecting arrangements 16 can take a number of different forms. For example, the walls 14 can be clipped to each other with complementary clipping arrangements. Furthermore, the bolt and nut combinations can be replaced with rivets. Still further, flanges can be provided on respective vertical edges 18, the flanges being brought into abutment and fastened to each other for assembling the garden bed.

It will readily be appreciated that assembling the garden bed assembly 10 is a simple matter of placing the garden bed members 12 in position on a substrate and fastening the edges 18 to each other with the bolts 24 and wing-nuts 26, by hand. Furthermore, the garden bed assembly 10 can be supplied to the end user in a relatively compact package for transport by the end user. The fact that the walls 14 are of corrugated metal sheeting allows the garden bed assembly 10 to have a weight suitable for lifting and carrying by most able-bodied end-users or consumers.

It will also be appreciated that the garden bed members 12 can be provided in a number of different shapes to suit differently sized and shaped garden bed assemblies. For example, an embodiment of a modular wall assembly or kit can include four of the arcuate members 12.1. In another example, there can be provided four or more of the straight members 12.2 only. Furthermore, by providing various numbers and sets of the garden bed members 12, a consumer can combine or split kits of the invention to achieve larger or more garden bed assemblies of different shapes.

Applicant envisages that the garden bed members 12 can be of materials other than corrugated metal sheeting. For example, the garden bed members 12 can be of a plastics material or of fibre glass or of any other material which is both weather-resistant and of a weight that facilitates transport, packaging and sale at retail outlets which supply direct to the end-user.

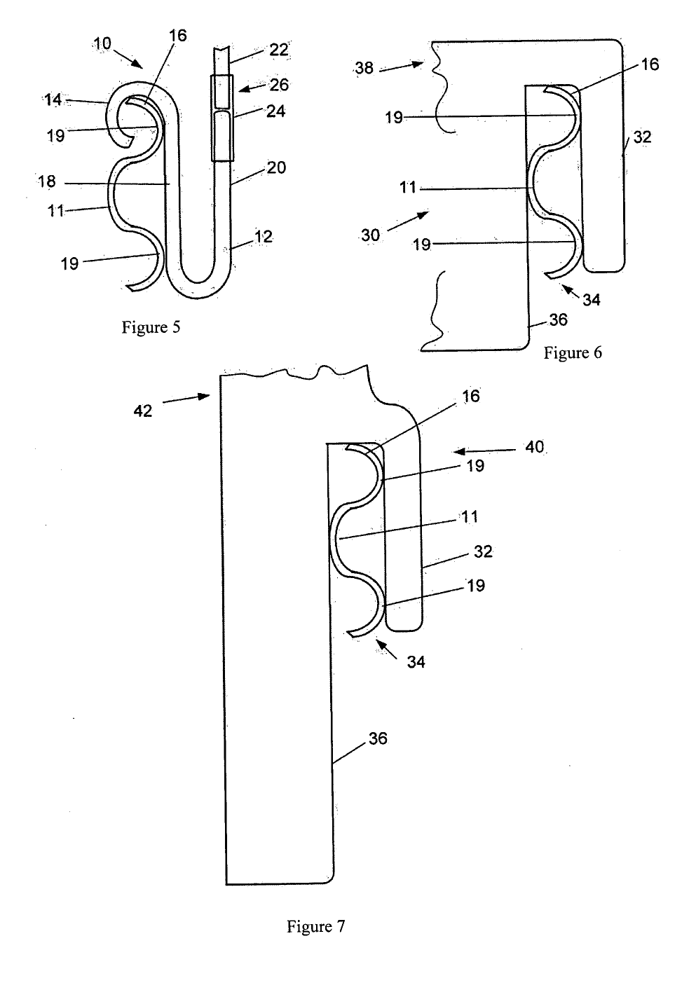

In FIG. 5, reference number 10 generally indicates a first embodiment, in accordance with the invention, of an accessory for a garden bed assembly.

In this embodiment, the garden bed assembly includes a number of walls of corrugated metal sheeting, indicated with reference number 11. It will readily be appreciated that the metal sheeting can be replaced with any other corrugated sheeting having suitable structural integrity for use as a garden bed.

The accessory 10 includes a mounting member in the form of a shaped steel bar 12. The bar 12 is shaped so that one end 14 can be hooked over a free edge 16 of the metal sheeting 11. An intermediate portion 18 of the bar 12 extends from the end 14 so that, when the end 14 is hooked over the free edge 16, the intermediate portion can extend operatively downwardly across at least two corrugations 19 with the relative orientation of the end 14 and intermediate portion 18 being such that the bar 12 is retained in position.

The bar 12 defines a support formation in the form of a return portion 20 that extends operatively upwardly.

In this embodiment, the accessory 10 is particularly suited for supporting posts 22 of a netting system (not shown) for use with the garden bed assembly. Thus, the accessory 10 includes a ferrule 24 that can be positioned on the return portion 20. The ferrule 24 defines a socket 26 in which the post 22 can be received.

In FIG. 6, reference number 30 generally indicates a second embodiment, in accordance with the invention, of an accessory for a garden bed assembly. With reference to FIG. 5, like reference numerals refer to like parts, unless otherwise specified.

In this embodiment, the mounting member is in the form of a carrier 32 that defines a recess 34 with a generally rectangular transverse profile. In use, the carrier 32 is oriented with the recess 34 facing downwardly so that the free edge 16 of the metal sheeting 11 can be received in the recess 34 with at least two corrugations 19 positioned in the recess 34. Furthermore, the recess 34 is dimensioned so that the carrier 32 can be clipped on to the corrugations 19 such that the carrier 32 is retained in position.

The support formation is in the form of a support structure 36 configured to support a workbench or table generally indicated with reference number 38. Thus, this embodiment can be used to support various items that are used for gardening.

In FIG. 7, reference number 40 generally indicates a third embodiment, in accordance with the invention, of an accessory for a garden bed assembly. With reference to FIGS. 5 and 6, like reference numerals refer to like parts, unless otherwise specified.

In this embodiment, the support formation is in the form of a support structure 36 configured to support a trellis system, generally indicated with reference number 42.

It will be appreciated that the accessory 10, 30, 40 is particularly suited for assisting gardeners that choose to use garden bed assemblies of the type described above. In particular, the accessory 10, 30, 40 makes use of the corrugations 19 to achieve a secure fit on the garden bed assembly.

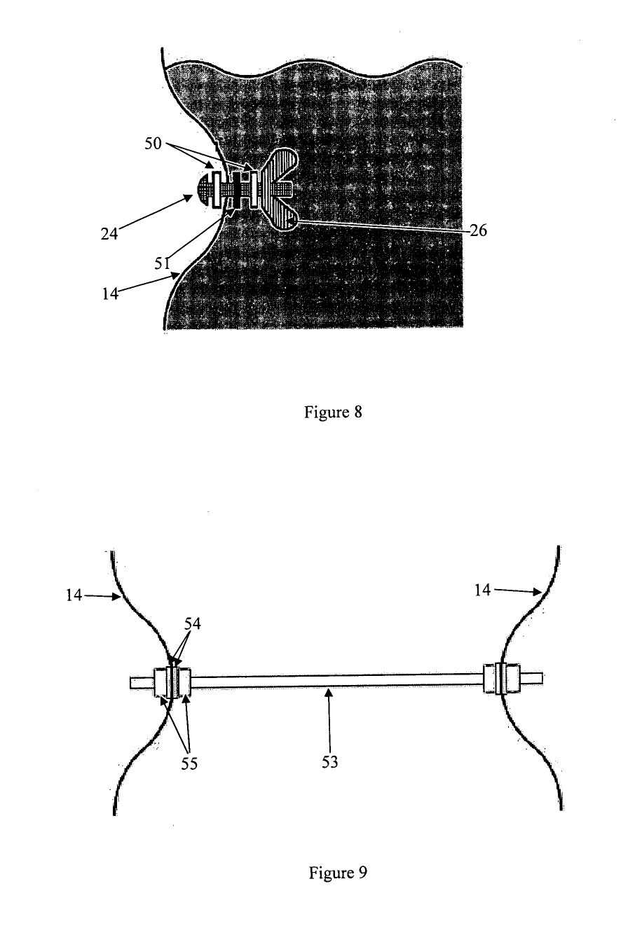

An alternative connecting arrangement is illustrated in FIG. 8. In this embodiment, a bolt 24 passes through the overlapped walls 14 of the bed with a metal washer 50 in between the head of the bolt 24 and the outer side of the wall. A rubber washer 51 is located adjacent an inner surface of the wall with a second metal washer 50 between the rubber washer 51 and the preferred wingnut 26.

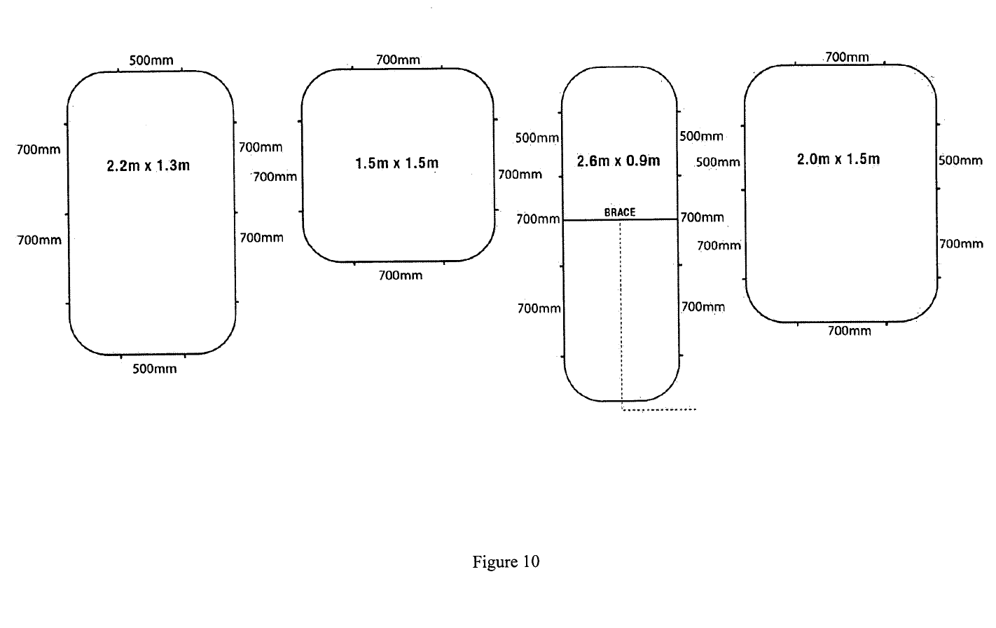

Alternative configurations of a modular bed are illustrated in FIG. 10. In circumstances where the narrow, 2.6 m×0.9 m garden bed is formed, this configuration requires a bracing assembly. One preferred form of bracing assembly is illustrated in FIG. 9 and includes a threaded rod 53 extending between the opposite walls of the bed with each sidewall received between a pair of washers 54 sandwiched between a pair of nuts 55.

The foregoing embodiments are illustrative only of the principles of the invention, and various modifications and changes will readily occur to those skilled in the art. The invention is capable of being practiced and carried out in various ways and in other embodiments. It is also to be understood that the terminology employed herein is for the purpose of description and should not be regarded as limiting.

The term “comprise” and variants of the term such as “comprises” or “comprising” are used herein to denote the inclusion of a stated integer or stated integers but not to exclude any other integer or any other integers, unless in the context or usage an exclusive interpretation of the term is required.

1. A modular garden bed assembly which comprises a plurality of garden bed members, each garden bed member including a wall and a connecting arrangement on each of a pair of opposed, operatively vertical ends of the wall, the garden bed members arranged consecutively with respect to each other, with connecting arrangements of respective consecutive walls connected to each other so that the walls bound a volume in which soil for planting can be retained by the walls.

2. A modular garden bed assembly as claimed in claim 1, in which each connecting arrangement includes a series of openings defined in respective said vertical edges of the walls such that the openings in consecutive walls can be brought into register with each other when said vertical ends of the consecutive walls overlap to permit the walls to be fastened to each other with fasteners received through the openings.

3. A modular garden bed assembly as claimed in claim 1, wherein the modular garden bed assembly is in the form of a kit.

4. An accessory for a garden bed assembly, the accessory comprising a mounting member configured for operative engagement with an operatively horizontal edge of a wall of the garden bed assembly; and a support formation arranged on the mounting member so that the mounting member can support a device for use with the garden bed assembly.

5. An accessory as claimed in claim 4, wherein the garden bed assembly is assembled from at least one sheet of corrugated material; and wherein the mounting member is configured so that it can be urged into engagement with a free edge of the sheet to engage respective corrugations defined by the sheet.

6. An accessory as claimed in claim 5, wherein the mounting member is in the form of a bar which is shaped so that one end can be hooked over said free edge of the sheet while an opposite end is shaped to define the support formation.

7. An accessory for a garden bed assembly, the accessory comprising a mounting member configured for operative engagement with an operatively horizontal edge of a wall of the garden bed assembly; and a support formation arranged on the mounting member; the support formation is in the form of a bench, and wherein the mounting member is in the form of a clip-on member so that the bench can be clipped onto the wall of the garden bed assembly.

8. An accessory for a garden bed assembly, the accessory comprising:
a mounting member configured for operative engagement with an operatively horizontal edge of a wall of the garden bed assembly; and
a support formation arranged on the mounting member;
the support formation is in the form of a trellis system, and
wherein the mounting member is in the form of a clip-on member so that the garden bed assembly can support the trellis system by clipping the mounting member onto the wall of the garden bed assembly.
